(19) United States
(12) Patent Application Publication
(10) Pub. No.: US 2008/0144540 A1
(43) Pub. Date: Jun. 19, 2008

(54) NETWORK SWITCHING APPARATUS AND NETWORK SWITCHING METHOD FOR COMPUTER SYSTEM

(75) Inventors: CHING SUNG CHANG, TAIPEI (TW); CHUN-CHEN CHAO, TAIPEI (TW); MING-HUI LIN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: TWINHEAD INTERNATIONAL CORP., TAIPEI (TW)

(21) Appl. No.: 11/782,997

(22) Filed: Jul. 25, 2007

(30) Foreign Application Priority Data
Dec. 19, 2006 (TW) 095147697

(51) Int. Cl. H04B 7/005

(52) U.S. Cl. 370/278

(57) ABSTRACT

The present invention discloses a network switching apparatus and a network switching method applied for switching between a wired network unit and a wireless network unit of a computer system. Based on the network switching method, the network switching apparatus includes a wired network unit, a wireless network unit and a control unit. The wired network unit includes a plug/unplug interface responsible for a wired network transmission. The wireless network unit is responsible for a wireless network transmission. The control unit includes a logic control circuit and a logic control unit or an embedded controller, and a basic input/output system (BIOS) of the computer system is used for pre-selecting setup options of the computer system, and detecting whether a network socket is plugged in or unplugged from a plug/unplug interface, so as to turn on or off the wired network transmission and wireless network transmission.

### BACKGROUND OF THE INVENTION

1. Field of the Invention

The present invention relates to a network switching apparatus and a network switching method for a computer system, and more particularly to a technical area that adopts a logic control circuit and a logic control unit or an embedded controller to control the function of switching a wired network and a wireless network through a basic input/output system (BIOS) of a computer system.

2. Description of the Related Art

At present, both cable and wireless network transmission technologies are available, and many technical journals have pointed out that there are methods and apparatuses for switching a wireless connection and a cable connection to transmit information and conduct communications. In other words, the wireless communication connection and the cable connection between users' mobile communication devices can be achieved concurrently, and some patents teach an automatic identification and logon apparatus and method for a wireless network, such that the communication of a handheld device can be executed in a wireless network environment, and various kinds of information of the handheld device can be detected by a wireless or a wired network information receiving/transmitting server automatically, and many patents teach a wired network switch applied in a wireless area network terminal as well. In other words, the wired network switch can detect the connection of a wireless network with at least two ports to assist the wireless network used in a computer network for receiving a data packet or sending the data packet to the computer network.

However, these technologies have not been practiced in personal computer devices, but the present personal computer devices are developed separately for the cable and wireless transmission technologies or applications, and the inventor of the present invention discovered that when a personal computer device uses its wired network transmission, the wireless network transmission of the personal computer device actually provides no assistance to the wired network transmission, and the wireless network transmission still occupies the resources of the personal computer device, such as occupying a portion of the main memory space and still consuming the power of the personal computer device. On the other hand, if a personal computer device uses its wireless network transmission, the wired network transmission still has the same drawbacks as described above.

Therefore, it is a subject for the present invention to find a way of using the wired network transmission and the wireless network transmission technologies most efficiently for a personal computer device. The inventor of the present invention based on years of experience on the research and development as well as actual practice in the related industry to provide a network switching apparatus and a network switching method for a computer system in hope of overcoming the aforementioned shortcomings of the prior art.

### SUMMARY OF THE INVENTION

Therefore, it is a primary objective of the present invention to provide a network switching apparatus and a network switching method for a computer system, such that if the computer system detects a wired network transmission, its wireless network transmission will turn off all resources occupied by the personal computer device automatically, so as to effectively release all occupied resources and achieve a power-saving effect. If the computer system detects a release of the using functions of the wired network transmission, then the necessary resources and functions of the wireless network transmission can be recovered.

Another objective of the present invention is to provide a network switching apparatus and a network switching method for a computer system, wherein the technical measures of a logic control circuit and a logic control unit or an embedded controller are adopted, and a basic input/output system (BIOS) of the computer system is used for controlling its function of switching the wired network and the wireless network, so as to produce the network switching apparatus in accordance with the present invention.

To achieve the foregoing objectives and characteristics of the present invention, the invention provides a network switching apparatus for a computer system and comprises a wired network unit, a wireless network unit and a control unit. The wired network unit such as an Ethernet card responsible for the wired network transmission comes with a plug/unplug interface such as the RJ45. The wireless network unit including the WLAN is responsible for a wireless network transmission. The control unit includes a logic control circuit and a logic control unit or an embedded controller, for detecting a plug/unplug interface being plugged into a network socket to turn on the wired network transmission and turn off the wireless network transmission, or detecting the plug/unplug interface being unplugged from the network socket to turn on the wireless network transmission and turn off the wired network transmission. It is noteworthy to point out that the logic control unit or the embedded controller can use a basic input/output system (BIOS) of the computer system to preset a setup option. For example, the setup option includes an ON button for turning off the wireless network unit to operate with a power supply for turning off the wireless network unit, or a power supply for turning on the wireless network unit, or a power supply for turning on or off the wireless network unit automatically according to the detection of the control unit. The setup option further includes an ON button function for maintaining the wireless network unit, or turning on or off a power supply of a wireless network unit automatically when the computer system is powered on, or keeping the lately used status as the latest setup option, when the power supply of the computer system is turned off.

In the aforementioned network switching apparatus, the present invention deducts and derives a network switching method for a computer system, and the method comprises the steps of:
(a) utilizing a control unit to detect a plug/unplug interface of a wired network unit that is plugged into a network socket;
(b) enabling the function of a wired network transmission of the wired network unit and disabling the function of a wireless network transmission of the wireless network unit, and releasing the resources occupied by the wireless network unit and their power supply, if the control unit detects that the plug/unplug interface of the wired network unit is plugged into a network socket.
(c) enabling the function of a wireless network transmission of the wireless network unit and disabling the function of a wired network transmission of the wired network unit and releasing the resources occupied by the wired network unit and their power supply, if the control unit detects that the plug/unplug interface of the wired network unit is unplugged from the network socket.

It is noteworthy to point out that the elements of the network switching method are the same as the elements of the network switching apparatus. In addition, the control unit also includes a logic control circuit and a logic control unit or embedded controller. The setup options required by the logic control unit or embedded controller can be preset through a basic input/output system (BIOS) of the computer system. For example, if the control unit detects that the plug/unplug interface of the wired network unit is plugged into a network socket, the ON button of the wireless network unit will be turned off, and the power supply of the wireless network unit will be turned off, or the power supply of the wireless network unit will be turned on, or the power supply of the wireless network unit will be turned on or off automatically according to the detection of the control unit, or an ON button function of the wireless network unit is maintained, such that if the power supply of the computer system is turned on, the power supply of the wireless network unit will be turned on or off, and if the power supply of the computer system is turned off, the lately used status is kept as the latest setup option.

To make it easy for our examiner to understand the technical characteristics and effects of the present invention, we use preferred embodiments and related drawings for the detailed description of the present invention as follows.

### BRIEF DESCRIPTION OF THE DRAWINGS

FIG. 1 is a schematic block diagram of a network switching apparatus of the present invention;

FIG. 2 is a flow chart of a network switching method for a computer system in accordance with the present invention; and

FIG. 3 is another flow chart of a network switching method for a computer system in accordance with the present invention.

### DETAILED DESCRIPTION OF THE PREFERRED EMBODIMENTS

In the following description of a network switching apparatus and a network switching method for a computer system in accordance with a preferred embodiment, different numerals are used for representing different elements, and a notebook computer is used as an example of the computer system for the illustration.

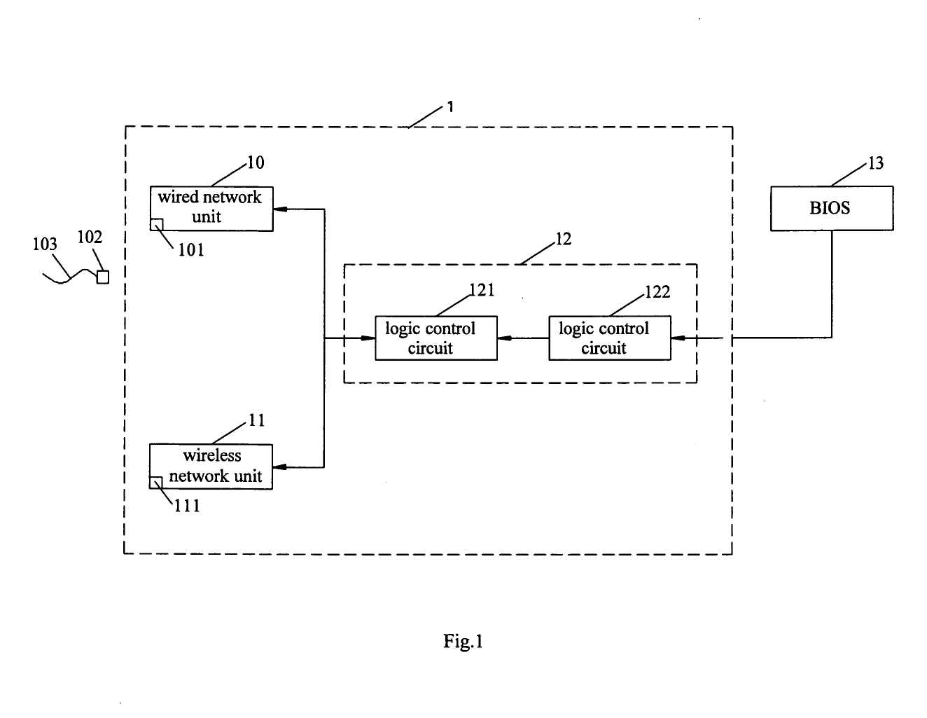

Referring to FIG. 1 for a schematic block diagram of a network switching apparatus of the present invention, the network switching apparatus 1 comprises a wired network unit 10, a wireless network unit 11 and a control unit 12. In this embodiment, the wired network unit 10 includes an Ethernet card responsible for a wired network transmission via the Ethernet, and the wired network unit 10 also installs a RJ45 plug/unplug interface 101 (which is usually a female connector) for plugging or unplugging a network cable 103 of an external RJ45 network socket 102 (which is usually a male connector). The wireless network unit 11 includes a WLAN device responsible for the Internet transmission via WLAN, and the wireless network unit 11 generally conducts a connection and a transmission with the outside through an antenna 111. In this embodiment, the control unit 12 includes a logic control circuit 121 and a logic control unit 122 (or an embedded controller). The logic control circuit 121 is electrically coupled to the wired network unit 10 and the wireless network unit 11 and used as a switch control circuit between the wired network unit 10 and the wireless network unit 11. In addition, the logic control unit 122 (or the embedded controller) is electrically coupled to the logic control circuit 121, and the logic control circuit 121 is used for controlling and setting different functions such as turning on or off the wired network unit 10 and the wireless network unit 11, detecting whether or not a plug/unplug interface 101 is plugged into a network socket 102 to enable the function of a wired network transmission and disable the function of a wireless network transmission, or detecting whether or not the plug/unplug interface 101 is unplugged from the network socket 102 to enable the function of a wireless network transmission and disable the function of a wired network transmission. In this embodiment, a user can use the basic input/output system (BIOS) 13 of the computer system to preset different control options of the logic control unit 122 (or the embedded controller). For instance, the control options include an ON button for turning off the wireless network unit 11 to operate with a power supply for turning off the ON button, or a power supply for turning off the wireless network unit 11, or a power supply for turning on the wireless network unit 11, or a power supply for turning on or off the wireless network unit 11 or maintaining the ON button function of the wireless network unit 11 according to the detection of the control unit 12, and a power supply for turning on or off the wireless network unit 11 when the computer system is powered on, or keeping the lately used status as the latest setup option when the computer system is powered off.

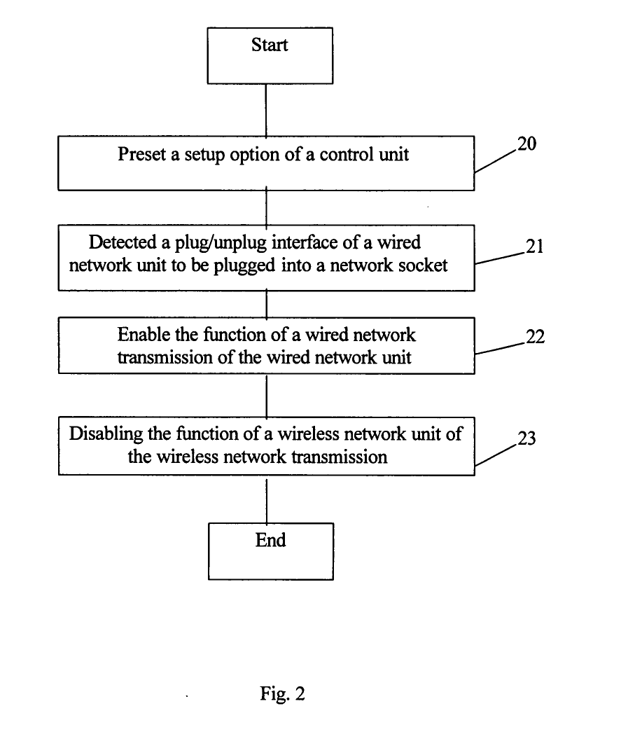

Referring to FIG. 2 for a flow chart of a network switching method for a computer system in accordance with the present invention, the network switching method comprises the steps of:

Step 20: presetting a setup option of a control unit;

Step 21: executing Steps 22 and 23 if it is detected according to the control options of the control unit that a plug/unplug interface of a wired network unit is plugged into a network socket;

Step 22: enabling the function of a wired network transmission of the wired network unit; and

Step 23: disabling the function of a wireless network unit of the wireless network transmission.

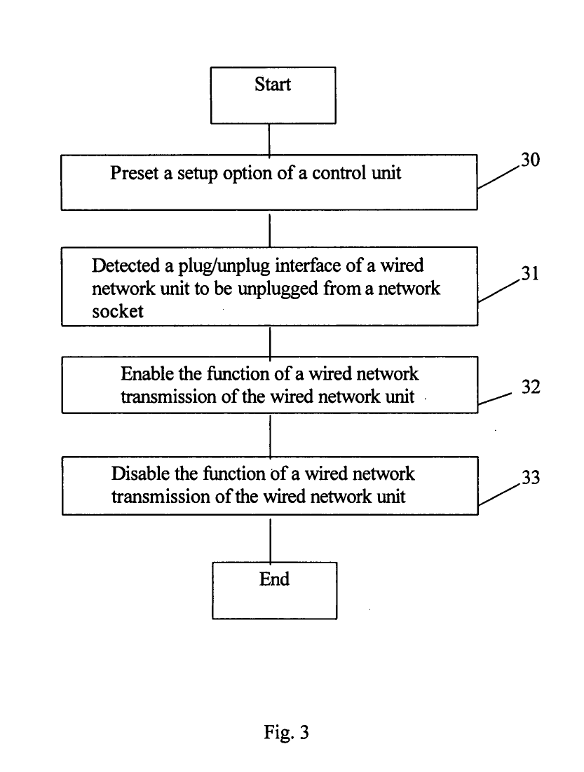

Referring to FIG. 3 for another flow chart of a network switching method for a computer system in accordance with the present invention, the network switching method comprises the steps of:

Step 30: presetting a setup option of a control unit;

Step 31: executing Steps 32 and 33 if it is detected according to the control options of the control unit that a plug/unplug interface of a wired network unit is unplugged from into a network socket;

Step 32: enabling the function of a wireless network transmission of the wireless network unit; and

Step 33: disabling the function of a wired network transmission of the wired network unit.

It is noteworthy that the network switching methods of the two preferred embodiments can preset the setup options of the control unit through the basic input/output system (BIOS) of the computer system, and the setup options also can be burned directly into the control unit. Further, the setup options in accordance with the preferred embodiments further include an ON button for turning off the wireless network unit to operate with a power supply for turning off the wireless network unit or a power supply for turning on the wireless network unit, or a power supply for turning on or off the wireless network unit automatically according to the detection of the control unit, or an ON button for maintaining the wireless network unit, and a power supply for turning on or off the wireless network unit automatically when the computer system is powered on, or keeping the lately used status as the latest setup option when the computer system is powered off.

Only some embodiments of the present invention have been illustrated in the drawings, but it should be pointed out that many other modifications are conceivable within the scope of the following claims. These modifications include but not limited to the elements of the preferred embodiments are software, hardware, firmware or any combination or the wired network unit is an Ethernet unit or the wireless network unit is a WLAN unit.

What is claimed is:

1. A network switching apparatus for a computer system, comprising:
a wired network unit, installing a plug/unplug interface, responsible for a wired network transmission;
a wireless network unit, responsible for a wireless network transmission; and
a control unit, for detecting said plug/unplug interface being plugged into a network socket to turn on said wired network transmission and turn off said wireless network transmission, or detecting said network socket being unplugged from said plug/unplug interface to turn on said wireless network transmission and turn off said wired network transmission.

2. The network switching apparatus of claim 1, wherein said control unit includes a logic control circuit and a logic control unit or an embedded controller.

3. The network switching apparatus of claim 2, wherein said logic control unit or said embedded controller are used for presetting a setup option through a basic input/output system (BIOS) of said computer system.

4. The network switching apparatus of claim 3, wherein said preset setup option includes turning off an ON button of said wireless network unit and turning off a power supply of said wireless network unit or turning on a power supply of said wireless network unit or automatically turning off or tuning on a power supply of said wireless network unit according to the detection of said control unit.

5. The network switching apparatus of claim 3, wherein said preset setup option includes an ON button function of said wireless network unit, such that if said computer system is powered on, a power supply of said wireless network unit will be turned on or off automatically, or a using status of said wireless network unit when said computer system is powered off.

6. A network switching method for a computer system, applicable for said computer system, and comprising a wired network unit and a wireless network unit, and said network switching method comprising the steps of:
utilizing a control unit to detect a plug/unplug interface of said wired network unit that is plugged into a network socket; and
enabling the function of a wired network transmission of said wired network unit and disabling the function of a wireless network transmission of said wireless network unit.

7. The network switching method of claim 6, wherein said control unit includes a logic control circuit and a logic control unit or an embedded controller.

8. The network switching method of claim 7, wherein said logic control unit or said embedded controller uses a basic input/output system (BIOS) of said computer system to preset a setup option.

9. The network switching method of claim 8, wherein said preset setup option includes turning off an ON button of said wireless network unit and turning off a power supply of said wireless network unit or turning on a power supply of said wireless network unit or automatically turning off or tuning on a power supply of said wireless network unit according to the detection of said control unit.

10. The network switching method of claim 8, wherein said preset setup option includes maintaining an ON button function of said wireless network unit, such that when said computer system is powered on, a power supply of said wireless network unit is automatically turned on or turned off, or a using status of said wireless network unit is maintained when said computer system is powered off.

11. A network switching method for a computer system, applicable for said computer system, comprising a wired network unit and a wireless network unit, and said network switching method comprising the steps of:
utilizing a control unit to detect a plug/unplug interface of said wired network unit that is unplugged from a network socket; and
enabling the function of a wireless network transmission of said wireless network unit, and disabling the function of a wired network transmission of said wired network unit.

12. The network switching method of claim 11, wherein said control unit includes a logic control circuit and a logic control unit or embedded controller.

13. The network switching method of claim 12, wherein said logic control unit or said embedded controller uses a basic input/output system (BIOS) of said computer system to preset a setup option.

14. The network switching method of claim 13, wherein said preset setup option includes turning off an ON button of said wireless network unit and turning off a power supply of said wireless network unit or turning on a power supply of said wireless network unit or automatically turning off or tuning on a power supply of said wireless network unit according to the detection of said control unit.

15. The network switching method of claim 13, wherein said preset setup option includes an ON button function for maintaining said wireless network unit, such that if said computer system is powered on, a power supply of said wireless network unit will be turned on or off automatically, or a using status of said wireless network unit if said computer system is powered off.
